(19) United States
(12) Patent Application Publication
(10) Pub. No.: US 2005/0010872 A1
(43) Pub. Date: Jan. 13, 2005

(54) Look and feel to enhance usability on Unix platforms

(75) Inventors: Letitia K. Lee, San Jose, CA (US); Siu-Nang See, Milpitas, CA (US); Frederick Thomas Sharp, Menlo Park, CA (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: International Business Machines Corporation

(21) Appl. No.: 10/614,687

(22) Filed: Jul. 7, 2003

(51) Int. Cl. G09G 5/00

(52) U.S. Cl. 715/744; 345/619; 345/661; 345/581; 715/811; 715/837; 715/765; 715/747

(57) ABSTRACT

A “Motif look and feel” of a component in a graphical user interface (GUI) on a Unix platform is distinguishable based on selection and enablement properties. The appearance and behavior of the component, such as a check box is altered from the traditional “Motif look and feel.”

### BACKGROUND

1. Field of the Invention

The present invention generally relates to the “look and feel” of graphical user interfaces (GUI) on Unix platforms. In particular, it relates to the appearance and behavior of elements in a layout that have particular selection and enablement properties.

2. Description of the Related Art

Often applications run on different platforms so that the same application appears differently on the different platforms. The “look and feel” of a graphical user interface (GUI) governs the appearance and the behavior of user interface controls in different platforms. The “look and feel” of the GUI when an application is running in a Microsoft Windows® operating system is “Windows Look and Feel.” The “look and feel” of the GUI when the GUI is running on X Windows in a Unix operating system is “Motif Look and Feel.” Examples of Unix operating systems are the Solaris Operating system available from Sun Microsystems, Santa Clara, Calif. and the Linux operating system available from various vendors. (For more information, see “The Single UNIX® Specification, Version 2” available from The Open Group, San Francisco, Calif.) The different “look and feel” for different platforms occurs in DB2®, which is available from International Business Machines Corporation (IBM®), New York, N.Y. DB2® includes Control Center, Task Center, and Replication Center and many others.

FIG. 1 shows an example of the “Windows Look and Feel” of checkboxes. Each checkbox is rendered using both a checkbox icon 100 and a label 102. There are four checkboxes, checkbox 104, checkbox 106, checkbox 108, and checkbox 110. Selection and enablement information for each of these checkboxes is provided in Table 1.

TABLE 1
Selection and Enablement for FIG. 1.

| | | Label | Icon | |
|---|---|---|---|---|
| Checkbox | State | Rendering | Rendering | Value |
| 104 | Enabled | Enabled | Enabled | Unchecked |
| 106 | Enabled | Enabled | Enabled | Checked |
| 108 | Disabled | Disabled | Disabled | Unchecked |
| 110 | Disabled | Disabled | Disabled | Checked |

In Table 1, an enabled state indicates that the user is allowed to edit the checkbox, while a disabled state means that the user cannot. Checkbox 104 and checkbox 106 have an enabled state; however, checkbox 108 and checkbox 110 have a disabled state. When label rendering is enabled, the label is in black font. When label rendering is disabled, the label is in gray font. Checkbox 104 and checkbox 106 have label rendering enabled; however, checkbox 108 and checkbox 110 have label rendering disabled. When icon rendering is enabled and the value is unchecked, a square with a white fill is rendered. Checkbox 104 has icon rendering enabled and the value is unchecked. When icon rendering is enabled and the value is checked, a square with a white fill and a check inside is rendered. Checkbox 106 has icon rendering enabled and the value is checked. When icon rendering is disabled, a square with a gray fill is rendered with or without a gray check depending on the value. Checkbox 108 has icon rendering disabled and the value is unchecked. Checkbox 110 has icon rendering disabled and the value is checked. It is sometimes hard to tell at a glance that checkbox 110 is checked. There is a need for a black check mark inside a grayed square in this case for clarification that the state of the checkbox is currently disabled and for ease of quick reading.

FIG. 2 shows an example of the “Windows Look and Feel” of checkboxes within a table. The “Windows Look and Feel” is not available on Unix platforms, only the “Motif Look and Feel” is available on Unix platforms. Note that no label is displayed beside the checkbox icons because they are inside a table. There is a need for a black check mark inside greed squares for clarity because the contrast between the gray check mark and the gray square fill is small.

FIG. 3 shows an example of the “Motif Look and Feel” of checkboxes. There is a problem with user confusion because for all the checkboxes 104, 106, 108, and 110, the checkbox icons 100 (squares) are rendered with a gray fill whether or not they are enabled or disabled so that it is hard to tell the difference. There is a need for a way to distinguish them at a glance. Selection and enablement information for each of these checkboxes is provided in Table 2.

TABLE 2
Selection and Enablement for FIG. 3.

| Checkbox | State | Label Rendering | Icon Rendering | Value |
|---|---|---|---|---|
| 104 | Enabled | Enabled | Enabled | Checked |
| 106 | Enabled | Enabled | Enabled | Unchecked |
| 108 | Disabled | Disabled | Disabled | Unchecked |
| 110 | Disabled | Disabled | Disabled | Checked |

FIG. 4 shows an example of the “Motif Look and Feel” for checkboxes within a table. The traditional “Motif Look and Feel” of checkboxes in table cells is confusing to users, because no labels are shown with the icon. This is because the traditional “Motif Look and Feel” uses only the label to render the value of the checkbox. In other words, the appearance of an enabled or disabled checkbox icon is the same, only the label changes appearance. The icons are provided in a Java Swing available from Sun Microsystems. Because the appearance of the checkbox icon is the same, it is very difficult for users to tell whether a checkbox is enabled or disabled. In FIG. 4, the first column of checkboxes is enabled and the second column of checkboxes is disabled. However, this is not apparent to users.

There is a need for altering the “Motif Look and Feel” to provide a distinction between the appearance of enabled and disabled components, such as checkboxes to avoid user confusion. This is particularly important when the component appears inside another component without the label, like it does in a table.

### SUMMARY OF THE INVENTION

A system for look and feel on a Unix platform comprises a computer system having a graphical user interface (GUI), a plurality of icons, and a component. The plurality of icons for the component are distinct according to their selection and enablement properties. The component is executable on the computer system and overrides a plurality of default icons for the component. The default icons do not adequately distinguish the component according to their selection and enablement properties. The component runs during initialization. The component is sometimes a checkbox.

When the checkbox is selected and enabled, it is rendered on the GUI as a square filled with white and a black check inside the square. When the checkbox is selected and disabled, it is rendered on the GUI as a square filled with gray and a black check inside the square. When the checkbox is unselected and enabled, it is rendered on the GUI as a square filled with white. When the checkbox is unselected and disabled, it is rendered on the GUI as a square filled with gray.

A method for look and feel on a Unix platform comprises providing a plurality of icons for a component of a graphical user interface that are distinct according to selection and enablement properties. A plurality of default icons are overridden for the component. The selection property is an indication of user selection of the component. The enablement property is an indication of whether the user is permitted to edit the component. Sometimes, the component is a checkbox. Sometimes, the checkbox is within a second component. Sometimes, the second component is a table.

These and other features, aspects, and advantages of the present invention will become better understood with reference to the following drawings, description, and appended claims.

### BRIEF DESCRIPTION OF THE DRAWINGS

FIG. 1 is an example of the prior art “Windows Look and Feel” of checkboxes.

FIG. 2 is an example of the prior art “Windows Look and Feel” of checkboxes within a table.

FIG. 3 is an example of the prior art “Motif Look and Feel” of checkboxes.

FIG. 4 is an example of the prior art “Motif Look and Feel” of checkboxes within a table.

FIG. 5 is an embodiment of “New Motif Look and Feel” checkbox icons having different selection and enablement properties according to the present invention.

FIG. 6 is an embodiment of “New Motif Look and Feel” checkboxes within a table according to the present invention.

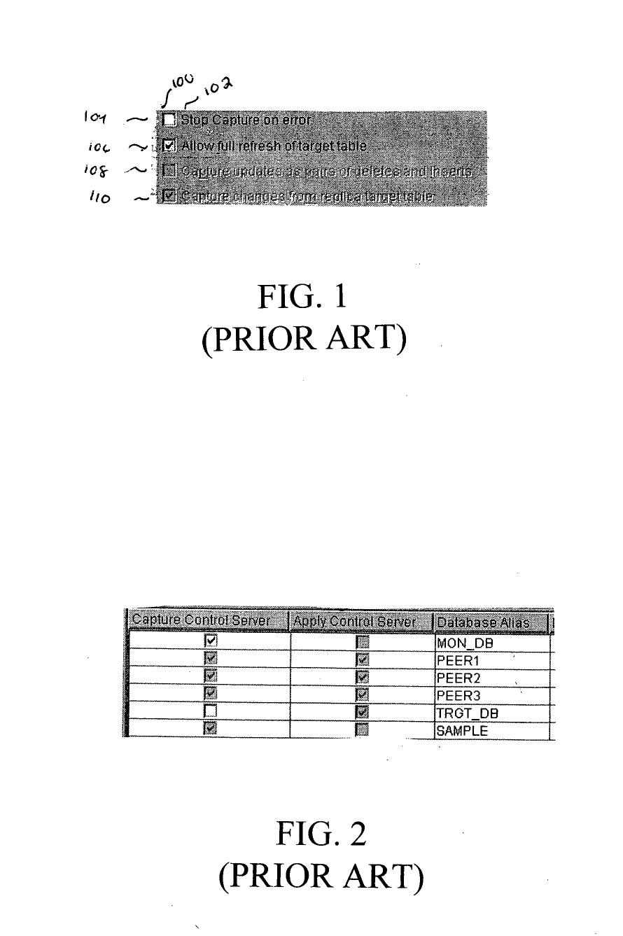

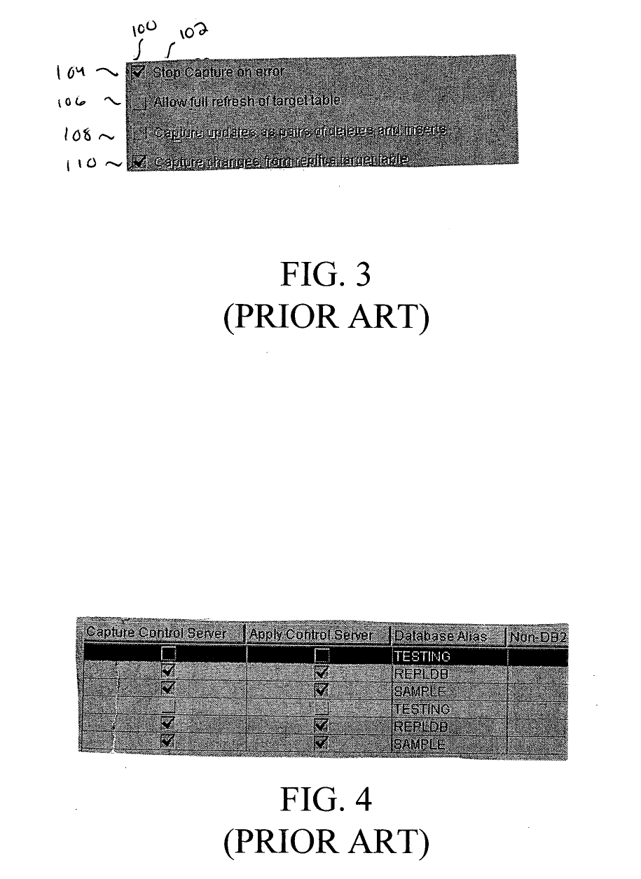

### DETAILED DESCRIPTION OF THE PREFERRED EMBODIMENTS

In the following detailed description, reference is made to the accompanying drawings. These drawings form a part of this specification and show, by way of example, specific preferred embodiments in which the present invention may be practiced.

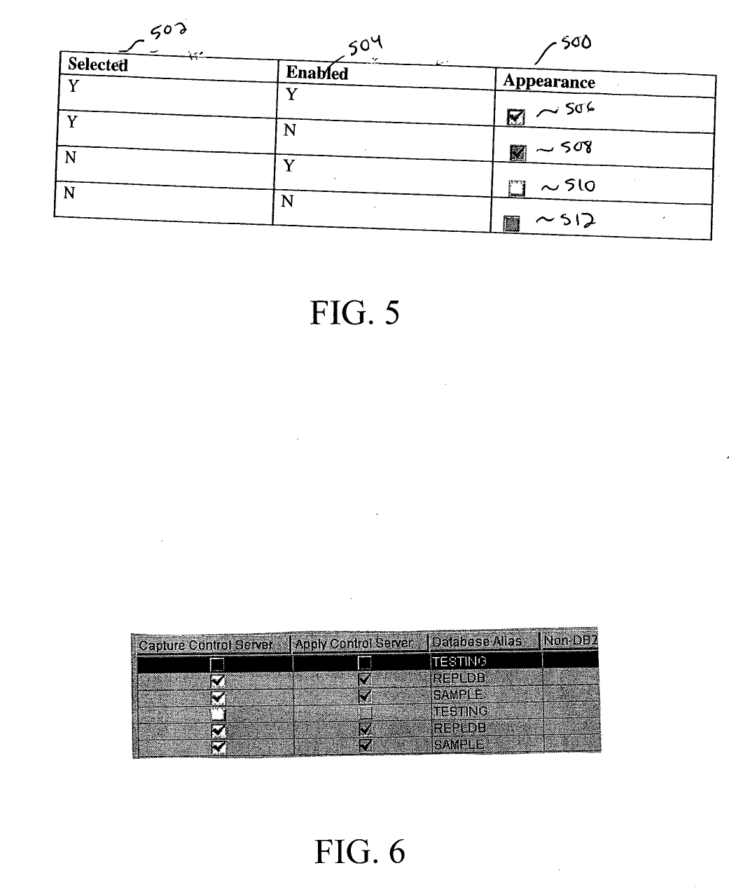

FIG. 5 shows an embodiment of “New Motif Look and Feel” checkbox icons having different selection and enablement properties according to the present invention. The present invention alters the “Motif Look and Feel” to provide a distinction in the appearance according to the selection and enablement properties. One embodiment of the present invention is a plurality of icons having an appearance 500 according to the selection 502 and enablement 504 properties. As a consequence, the users are not confused between enabled and disabled checkboxes, even when they appear within tables without labels. A selected checkbox has a check within the square. An enabled checkbox allows the user to edit it. In FIG. 5, there are four example icons having a distinguishing appearance so that a user is not confused. A selected and enabled checkbox 506 is a square filled with white and a black check inside. A selected and disabled checkbox 508 is a square filled with gray and a black check inside. An unselected and enabled checkbox 510 is a square filled with white. An unselected and disabled checkbox 512 is a square filled with gray. These are examples. The present invention applies to any control that has an icon and a label, such as radio buttons, combo boxes, text entry fields, and the like. The present invention contemplates variations in color and shape so long as the distinction is made clear. For example, instead of black, white, and gray, colors could be used, such as blue, yellow, and red or various hues and tints of the same color. Also, in these examples, the outside of the square is shadowed and outlined in gray. Of course, the present invention contemplates various outlines and effects of the squares so long as the distinction is made clear. The example component is a checkbox, but other components having the same problem can be similarly corrected.

FIG. 6 shows an embodiment of “New Motif Look and Feel” checkboxes within a table according to the present invention. In an example embodiment, the new icons shown in FIG. 5 override the default icons on the Unix platform. This is done during initialization. Plurality of icons 500 shown in FIG. 5 are used in FIG. 6 so that it is clear to the user that the first column of checkboxes is enabled and the second column of checkboxes is disabled. By contrast, the old “Motif Look and Feel” as shown in FIG. 4 is confusing. With the present invention, this is now apparent to users and the difference can be seen at a glance.

An example method according to the present invention is illustrated with the following example pseudocode.
Class DB2MotifLookAndFeel is a subclass of com.sun.java.swing.plaf.motif.MotifLookAndFeel
Inside class DB2MotifLookAndFeel,

// UlDefaults table is the object which has contains all controls objects, eg. checkboxes, radio buttons, and etc.

method initComponentDefaults (UIDefaults table) {
add the new icon and the class represents the new checkbox
(MotifCheckBoxIcon) in the table
}

class MotifCheckBoxIcon
this is a class which represents the icon.
the paintIcon was overridden to present the icon in the following states in a customized fashion.
   Different States of the Icon.
1. boolean isPressed=implementation to render the icon when the checkbox is being pressed or is selected.
2. boolean isArmed=implementation to render the icon when the checkbox is pressed or is selected.
3. boolean isEnabled=implementation to render the icon when the checkbox is enabled.
4. boolean isSelected=implementation to render the icon when the checkbox is selected.
5. checkToggleIn—a combination of state 12,4 // toggled from unchecked to checked
6. uncheckToggleOut—a combination of state 1, 2, 4 // toggled from checked to unchecked
7. checkIn, a combination of state 1, 2, 4 // show checked, unpressed state
8. flat—// show unchecked state

It is to be understood that the above description is intended to be illustrative and not restrictive. Many other embodiments will be apparent to those of skill in the art upon reviewing the above description, such as components other than checkboxes. Various types of components are contemplated by the present invention, such as radio buttons, textfields, and the like. Also, a consistent and unique “look and feel” is preferred across all the components. The present invention has applicability to all Java tools implemented using the Swing library. Therefore, the scope of the present invention should be determined with reference to the appended claims, along with the full scope of equivalents to which such claims are entitled.

1. A system for look and feel on a Unix platform, comprising:
a computer system having a graphical user interface (GUI);
a plurality of icons for a component of said GUI that are distinct according to a selection property and an enablement property; and
a software component executable on said computer system to override a plurality of default icons for said component.

2. The system according to claim 1, wherein said software component runs during initialization.

3. The system according to claim 1, wherein said component is a checkbox.

4. The system according to claim 3, wherein said checkbox has a selected property and an enabled property and is rendered on said GUI as a square filled with white and a black check inside said square.

5. The system according to claim 3, wherein said checkbox has a selected property and a disabled property and is rendered on said GUI as a square filled with gray and a black check inside said square.

6. The system according to claim 3, wherein said checkbox has a unselected property and an enabled property and is rendered on said GUI as a square filled with white.

7. The system according to claim 3, wherein said checkbox has a unselected property and a disabled property and is rendered on said GUI as a square filled with gray.

8. A method for look and feel on a Unix platform, comprising:
providing a plurality of icons for a component of a graphical user interface that are distinct according to selection and enablement properties; and
overriding a plurality of default icons for said component.

9. The method according to claim 8, wherein said selection property is an indication of user selection of said component.

10. The method according to claim 8, wherein said enablement property is an indication of whether editing of said component is permitted.

11. The method according to claim 8, wherein said component is a checkbox.

12. The method according to claim 8, wherein said checkbox is within a second component.

13. The method according to claim 12, wherein said second component is a table.

14. A computer-readable medium having computer-executable instructions for performing a method, comprising:
providing a plurality of icons for a component of a graphical user interface that are distinct according to selection and enablement properties; and
overriding a plurality of default icons for said component.

15. The computer-readable medium according to claim 14, wherein said component is a checkbox.

16. The computer-readable medium according to claim 14, wherein said checkbox has a selected property and an enabled property and is rendered on said GUI as a square filled with a light color and a dark-colored check inside said square.

17. The computer-readable medium according to claim 14, wherein said checkbox has a selected property and a disabled property and is rendered on said GUI as a square filled with a medium color and a dark-colored check inside said square.

18. The computer-readable medium according to claim 14, wherein said checkbox has a unselected property and an enabled property and is rendered on said GUI as a square filled with a light color.

19. The computer-readable medium according to claim 14, wherein said checkbox has a unselected property and a disabled property and is rendered on said GUI as a square filled with a medium color.
